(19) United States
(12) Patent Application Publication
(10) Pub. No.: US 2010/0088439 A1
(43) Pub. Date: Apr. 8, 2010

(54) INTELLIGENT CASE FOR HANDHELD COMPUTER

(75) Inventors: Cheng Siang Nicholas Ang, Gisborne (AU); David Graeme Cherry, Lake Wendouree (AU)

Correspondence Address: Workman Nydegger;1000 Eagle Gate Tower, 60 East South Temple, Salt Lake City, UT, 84111, US

(73) Assignee: ENTERMO LIMITED, Ballarat, Victoria (AU)

(21) Appl. No.: 12/593,039

(22) PCT Filed: Jun. 13, 2008
(86) PCT No.: PCT/AU08/00832

§ 371 Date: Nov. 13, 2009

(30) Foreign Application Priority Data
Jun. 13, 2007 (AU) 2007903262
Feb. 18, 2008 (AU) 2008900746

(51) Int. Cl. G06F 3/00; G06K 7/10; G06F 13/14; G06F 1/26; G06F 9/30

(52) U.S. Cl. 710/105; 361/679.41; 235/472.01; 713/340; 712/229; 712/E09.016

(57) ABSTRACT

An intelligent case for a handheld computer, the case including a compartment for removably housing the handheld computer; a microcontroller; a first communication device to enable communication between the handheld computer and the microcontroller; one or more recesses for housing one or more data-capture modules; and a second communication device to enable communication between the data-capture modules and the microcontroller; wherein the microcontroller includes: a module manager adapted to handle activation of the data-capture modules, collection of data from the data-capture modules, and communication of the collected data to the hand-held computer; and a first set of applications for controlling, in a first mode, at least some operations of the module manager independently of the handheld computer.

The present invention relates generally to handheld computers, such as personal digital assistants (PDAs), smartphones, portable communication devices and the like, and in particular to electronic accessories adapted for use with such computers.

PDAs, smart phones or other portable communication devices are today widely used. Most standard devices of this type are targeted at white collar workers for use in sending and receiving email, phone messages and in some cases enterprise based applications. These devices are ill suited to the harsh environments often encountered by blue collar workers. In response to this need, some handheld computers are provided with a ruggerdised casing, in order to resist against the harsh environment in which they are used. Moreover, the functionality of handheld computers is sometimes required to be augmented with additional data-capture devices, such as barcode scanners for use in scanning barcodes affixed to packaging and other items used in industry. Accordingly, there are now a limited number of handheld computers that have been augmented with barcode scanning capabilities and enclosed in ruggerdised casing, for use in industrial applications.

However, whilst these devices are suitable for use in an industrial environment, they are frequently to bulky and cumbersome for use in an office or private environment. Moreover, ruggerdised handheld computers with additional integrated functionality are often only suited to one particular application. Users may therefore be required to purchase two or more handheld computing devices depending on the various environments in which they find themselves, and the various applications requiring use of a handheld computer.

It would be desirable to enable the use of a handheld computer in a variety of environments and for a variety of applications without requiring the purchase of multiple separate devices. It would also be desirable to take advantage of the benefits of a handheld computer in a flexible manner. It would also be desirable to enable the use of a handheld computer in a manner that ameliorates or overcomes disadvantages of the prior art, or at least provides an alternative thereto.

With this in mind, one aspect of the invention provides an intelligent case for a handheld computer. The case includes a compartment for removably housing the handheld computer, a microcontroller, a first communication device to enable communication between the handheld computer and the microcontroller, one or more recesses for housing one or more data-capture modules, and a second communication device to enable communication between the data-capture modules and microcontroller. The microcontroller includes a module manager adapted to handle activation of the data-capture modules, collection of data from the data-capture modules, and communication of the collected data to the handheld computer. The microcontroller further includes a first set of applications for controlling, in a first mode, at least some of the operations of the module manner independently of the handheld computer.

Advantageously, an intelligent case having these features enables conventional handheld computers to be used in an industrial environment and in a flexible manner. Various data-capture modules can be housed within the intelligent case according to the desired application. The functionality of the handheld computer is extended by the module manger in the microcontroller so that interaction with the various data-capture modules is handled by the module manger, and the handheld computer need not be concerned with these functions. Different data capture methods, such as barcodes, scanning, signature capture and module data capture can be selected and caused to operate by a user without relying upon intelligence provided in the handheld computer. With an ability to adapt to a variety of handheld computers and applications in which they are intended to be used, the intelligent case reduces the footprint of multiple separate devices and combines them into a single handheld unit that is practical for field or industrial use.

The intelligent case may further include one or more user input devices, such as buttons, switches or the like. In this case, the microcontroller may be further adapted to activate one or more applications in response to operation of the user input devices. The applications activated in response to operation of the user input devices may be programmable.

In one or more embodiments, at least some operations of the module manager may be controlled, in a second mode, by a second set of applications stored on the handheld computer. The microcontroller may be adapted to be placed in either the first or second mode of operation. In one or more embodiments, the microcontroller is placed in either a first or second mode in response to operation of a user input device.

In this way, a user is able to selectively cause operation of the intelligent case in a “smart mode” relying upon intelligence provided in the integrated microcontroller or a “dumb mode” which relies upon intelligence provided in the handheld computer. Such selective operation of the intelligent case may be particularly advantageous, for example, to reduce the data processing burden placed on the handheld computer for a range of standard applications maintained in the intelligent case, but nevertheless enable a range of non-standard applications maintained in the handheld computer to be executed if desired.

The module manager may be further adapted to handle identification of available modules, activation of features available within each module, and/or power management of the data-capture modules.

The module manager may act to apply a date or time stamp to data captured from at least one of the data-capture modules. For example, the intelligent case may include a local clock, and the module manager may derive the date or time stamp from the local clock. Alternatively, the module manager may derive the date of time stamp from a local clock maintained by the handheld computer. In yet another embodiment, the intelligent case may include a GPS data-capture module, and the module manager may derive the date or time stamp from that GPS data-capture module.

The module manager may act to apply location information to the data captured from at least one of the data-capture modules. In one or more embodiments, the module manager may derive the location information from the GPS data-capture module.

The module manager may further act to apply user identification information to the data captured from at least one of the data-capture modules.

In that regard, the intelligent case may further include a user identification module, the module manager deriving the user identification information from the user identification module. The user identification module may capture user identification information from any one of a signature detection device, a biometric scanning device, PIN entry device or the like.

At least one or more of the data-capture modules may be built into the intelligent case. Alternatively, or in addition thereto, at least one of the data-capture modules may be removably affixed to or in the intelligent case.

The first communication device may establish a wireless communication link with the handheld computer. The wireless communication link may conform, for example, to the Bluetooth™ short range wireless connectivity standard.

Various types of data-capture modules for use with intelligent case are envisaged. For example, one of the data-capture modules may be a barcode scanner. Another of the data-capture modules may be a touchscreen controller for transmitting user input signals from a touchscreen forming part of the intelligent case to the microcontroller.

Another aspect of the invention provides a data monitoring system including one or more intelligent cases as described hereabove, where each case houses a handheld computer, and a central data monitoring station. The handheld computers are, in this data monitoring system, adapted to transmit data captured from the data-capture modules to the central data monitoring station.

The central data monitoring station may include one or more data monitoring stations for receiving and analysing data received from the handheld computers.

The foregoing has outlined rather broadly the features and technical advantages of the present invention so that the detailed description of the invention that follows may be better understood. Additional advantages and features of the invention will be described herein which form the subject of the claims of the invention. Those skilled in the art should appreciate that they can readily use the disclosed conception and specific embodiment as a basis for designing or modifying other structures for carrying out the same purposes of the present invention. Those skilled in the art should also realise that such equivalent constructions do not depart from the spirit and scope of the invention as set forth in the appended claims.

For a complete understanding of the present invention, and the advantages thereof, reference is now made in the following description taken in conjunction with the accompanying drawings, in which:

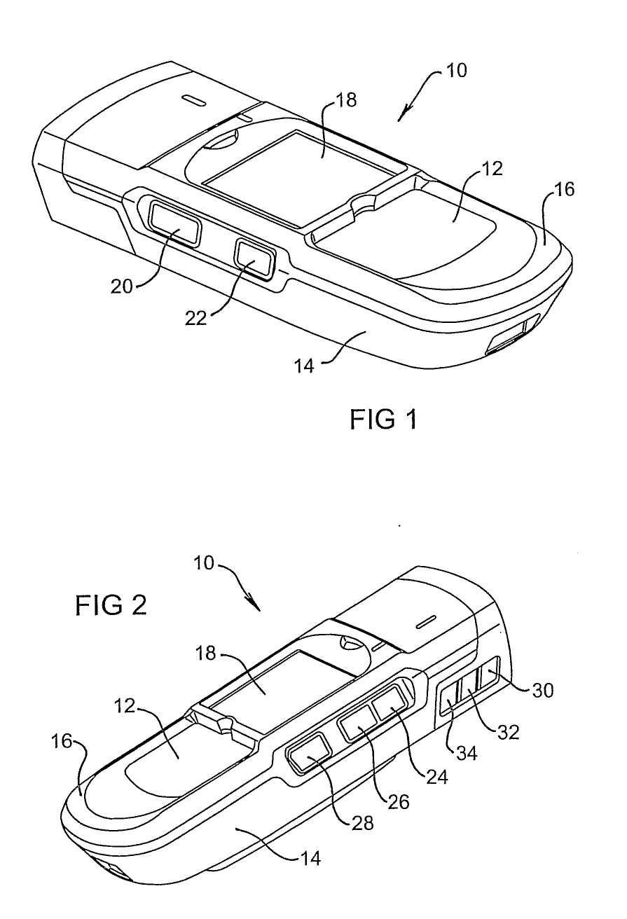

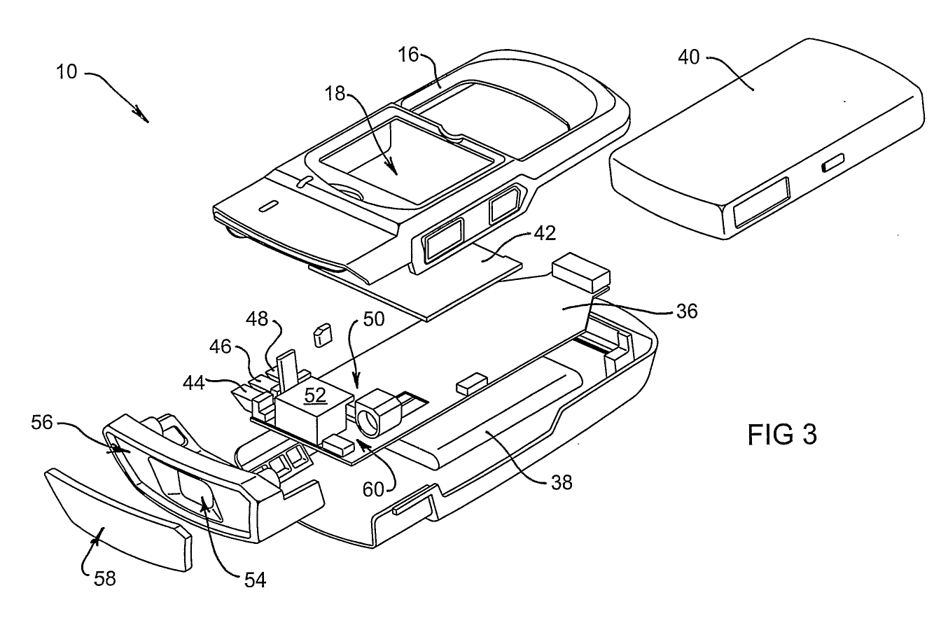

FIGS. 1 and 2 are perspective representations of one embodiment of an intelligent case for a handheld computer in accordance with the present invention;

FIG. 3 is an exploded view of the intelligent case in FIGS. 1 and 2;

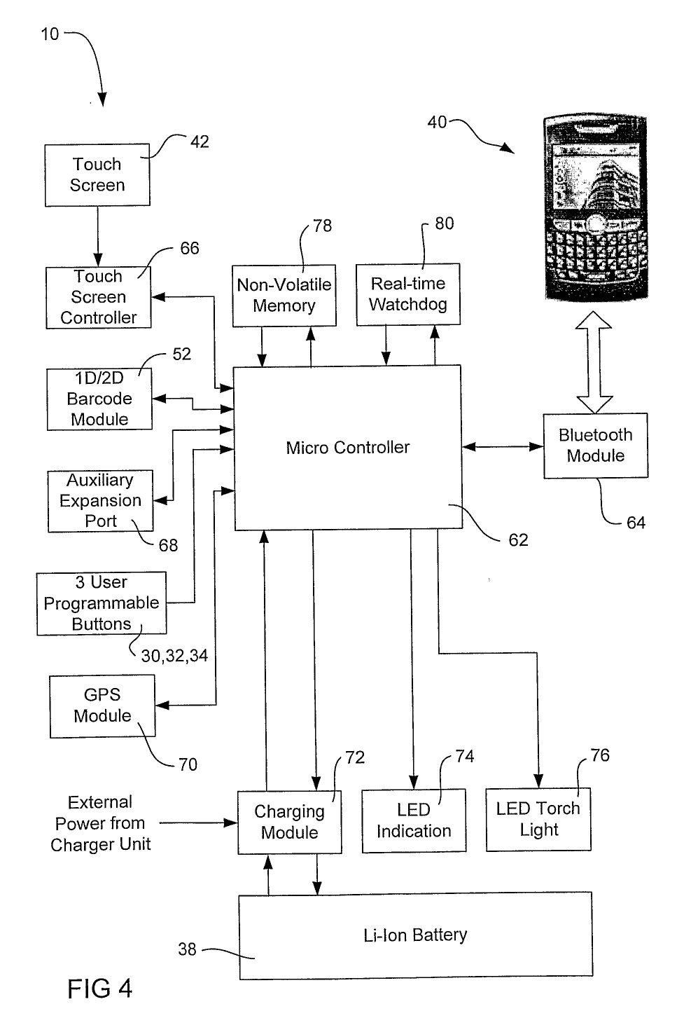

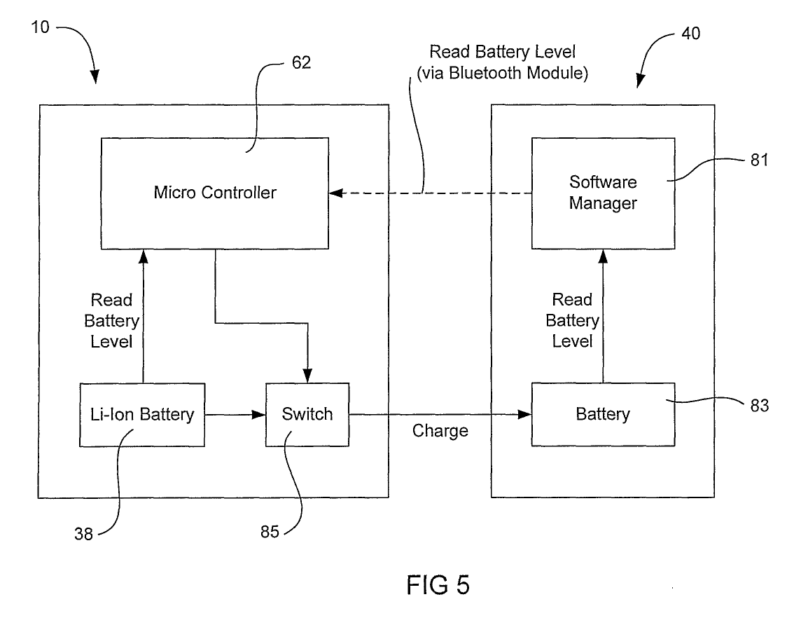

FIG. 4 is a schematic diagram of various components forming part of the intelligent case of FIGS. 1 to 3;

FIG. 5 is a schematic diagram of various components of the intelligent case of FIGS. 1 to 3 and a handheld computer that relate to a battery charging function;

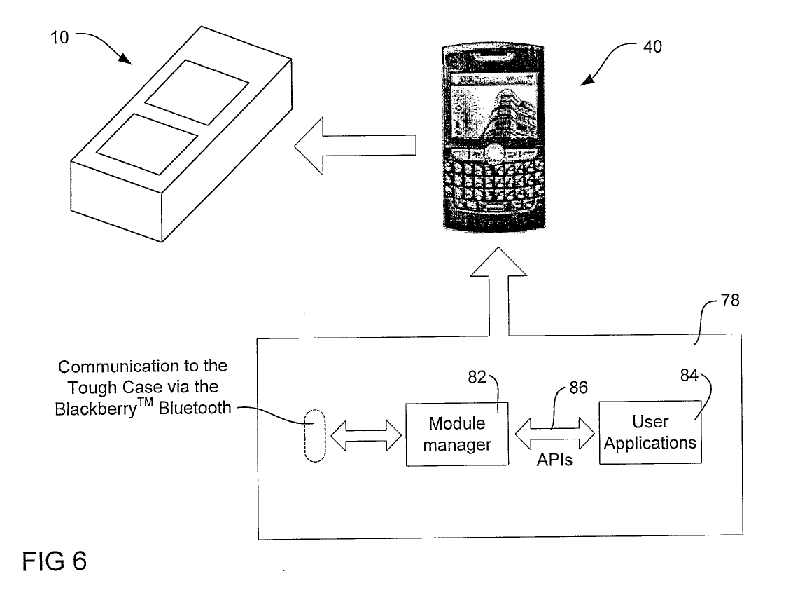

FIG. 6 is a schematic diagram illustrating functions performed by applications running on the various components shown in FIG. 4;

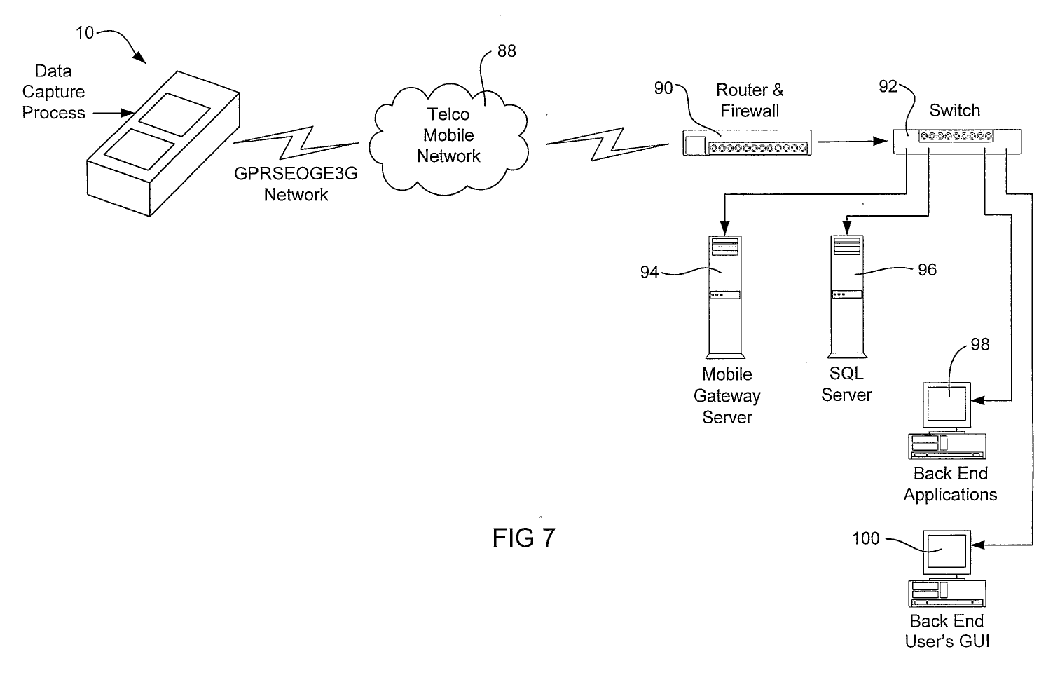

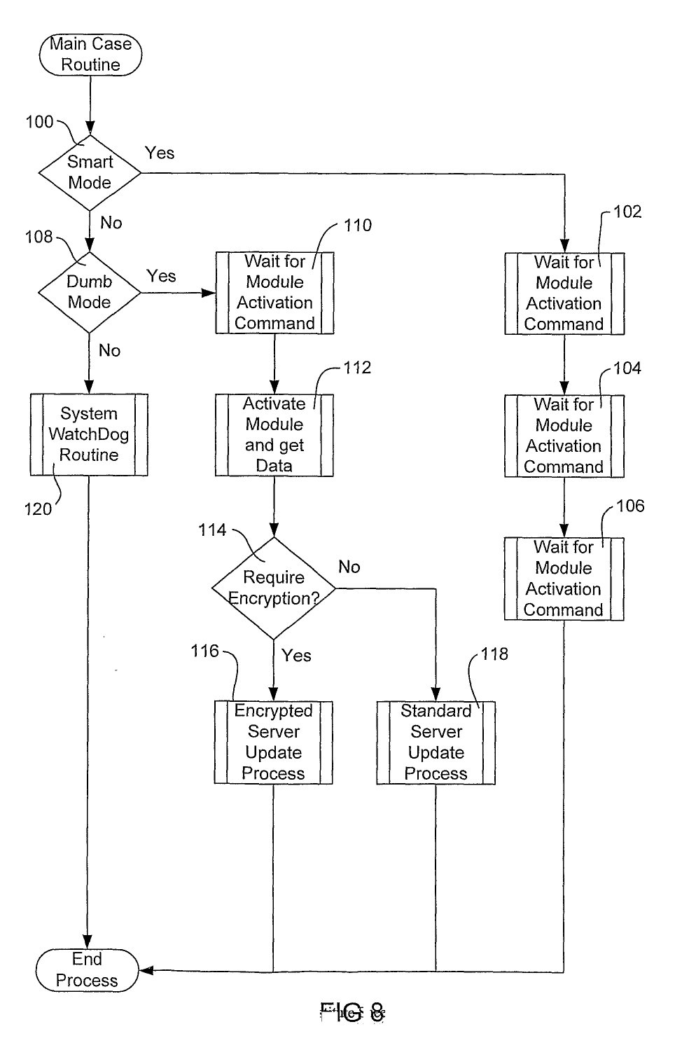

FIG. 7 is a schematic diagram of a data monitoring system including the intelligent case of FIGS. 1 to 6; and

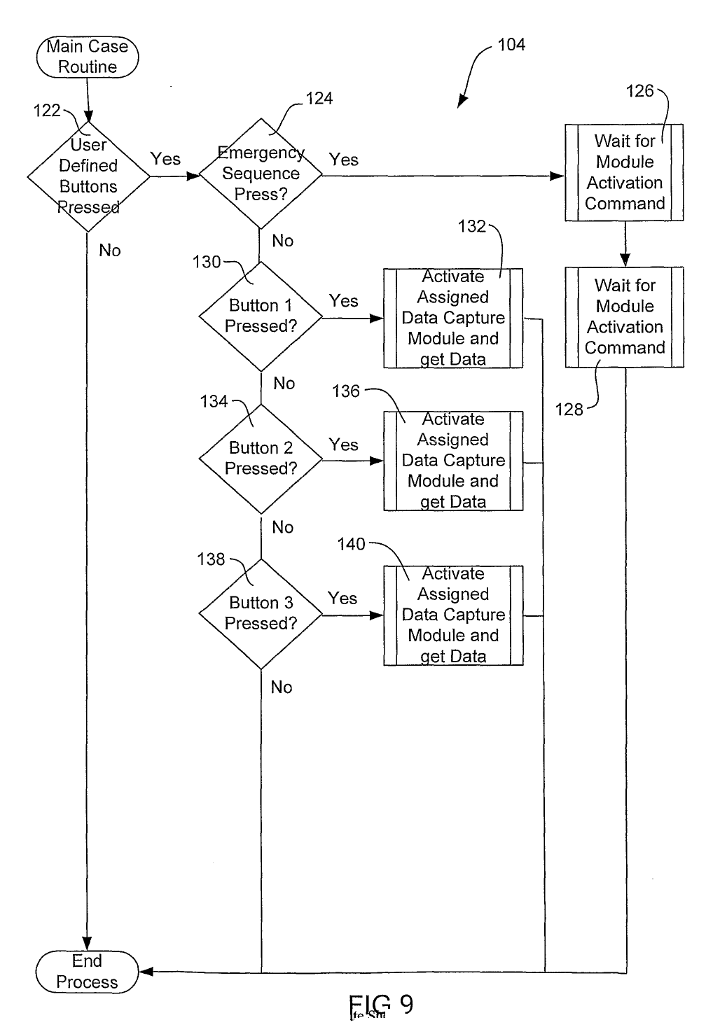

FIGS. 8 to 14 are flow charts depicting functional steps performed by the intelligent case and/or data monitoring system during operation.

Turning now to FIGS. 1 and 2, there is shown generally an intelligent case 10 for a handheld computer, such as a PDA, smart phone or other portable communications device. The intelligent case includes an outer shell made from a top half 12 and a bottom half 14 formed from high impact plastics and rubber with a water-tight seal between the two halves and held together by several screws along one side of the intelligent case 10. Apertures 16 and 18 are provided in the upper surface of the outer shell respectively to enable reviewing of a screen and operation of keys forming part of a handheld computer housed within the intelligent case 10. The intelligent case includes data access points 20 and 22 located along a first side of the outer shell. In this case, the data access points provide access to one or both of a microcomputer located within the intelligent case and the handheld computer. User operable buttons 24, 26 and 28 are provided on the other side of the outer shell to enable operation of corresponding buttons provided on the handheld computer housed within the intelligent case 10. In addition, three buttons or other user input devices 30, 32 and 34 are provided in the outer shell in order to provide user selectable inputs to a microcontroller forming part of the intelligent case.

As seen in FIG. 3, the intelligent case includes a main circuit board 36 on which is mounted a microcontroller and various other electronic components of the intelligent case 10. A battery unit 38 is also affixed to the main circuit board 36. A handheld computer 40 is located within the outer shell in such a manner that its keypad is positioned directly beneath the opening 18 in the upper half 16 of the outer shell. A touchscreen 42 may be located between the keypad of the handheld computer 40 and the opening 18.

The three buttons 30, 32 and 34 provided on the outer shell respectively interact with button stems 44, 46 and 48 mounted to the main circuit board 36 and providing a user input signal to a microcontroller mounted on the main circuit board when each of the buttons 30, 32 and 34 are depressed.

The intelligent case 10 includes, in this embodiment, two recesses for housing two data-capture modules. In a first recess 50, a barcode scanner module 52 is housed. Electronically connected to the main circuit board 36, the barcode scanner module 52 scans barcodes positioned beneath an opening 54 in a module cover 56. A scanning window 58 is provided over the opening 54 in the module cover 56.

A further recess 60 is provided in the intelligent case 10 in order to house an additional data-capture module, such as a GPS data-capture module, biometric scanning device or other removable or fixed data-capture modules. Other examples of data-capture modules that may be housed within the intelligent case 10 include a radio frequency identification (RFID) transceiver, a thumbprint scanner or other biometric identification device, a Pict-brige USB and memory card storage interface, a magnetic card reader, contact-based smart card reader or contact-less smart card reader. Various other examples will be apparent to those skilled in the relevant art.

Although not illustrated, the intelligent case 10 may include an aperture corresponding to the position of a built-in camera found in some handheld computers to allow pictures to be taken whilst the handheld computer is housed within the intelligent case 10. This opening may also house a high intensity LED torch that can be triggered by the user via one of the user definable buttons 30 to 34 or via software that may be activated from the handheld computer 40.

FIG. 4 is a schematic diagram illustrating various electronic components of the intelligent case 10. These electronic components include a microcontroller 62 and a communication device 64 to enable communication between the handheld computer 40 and the microcontroller 62. In this case, the communication device 64 is in the form of a Bluetooth™ module providing a short range wireless radio link to the handheld computer 40. A touchscreen controller 66 provides an interface between the touchscreen 42 and the microcontroller 62. In addition to the barcode module 52, an auxiliary expansion port 68 enables a removable data-capture module to be housed within the recess 60 and communicate with the microcontroller 62. Other data-capture modules, such as a GPS module 70 may also be either built-in or removably affixed to or in the intelligent case 10 so as to be in communication with the microcontroller 62.

A charging module 72 is provided so as to charge the battery 38 and provide power to the microcontroller 62 from an external power source when the charging module is provided with mains power. An LED indication lamp 74 and an LED torch light 76 are also provided in the intelligent case 10 and are driven by the microcontroller 62. A non-volatile memory 78 is associated with the microcontroller 62 and acts to store software in the form of a series of instructions for causing a microcontroller 62 to perform the various functions described herein. Finally, an internal clock 80 is provided within the intelligent case 10.

The intelligent case 10 also provides an intelligent charging function so that if the handheld computer 40 is running low on power, the intelligent case 10 acts to charge the handheld computer 40 from the battery 38. In that regard, the handheld computer 40 is mounted in the intelligent case 10 so that charge points (not shown) are accessible. A software manager 81 in the handheld computer 40 periodically monitors the level of charge in a battery 83 within the handheld computer 40, and communicates this charge level to the microcontroller 62 via the communication device 64. Similarly, the microcontroller 62 in the intelligent case 10 acts to monitor If the level of charge in a battery 38. If the monitored level of charge in the battery 83 falls below a predetermined value, and if there is sufficient available charge in the battery 38, then the microcontroller 62 causes operation of a switch 85 to enable the battery 38 to charge the battery 83 via the charge points.

Referring now to FIG. 6, the non-volatile memory 78 associated with the microcontroller 62 acts to store a middleware application known as a module manager 82. The module manager manages communication between user applications 84 via an application programming interface 86. The module manager 82 is adapted to activate the various data-capture modules shown in FIG. 4, collect data from those data-capture modules and communicate the collected data to the handheld computer 40. In addition, the module manager acts to identify modules that are available for use in the intelligent case 10, activate features available within each data-capture module, as well as providing power management of those modules.

As shown in this figure, at least some of the applications 84 may be maintained in the non-volatile memory 78 associated with the microcontroller 62 in order to control at least some of the operations of the module manager 82 independently of the handheld computer 40. The user input switches 30, 32 and 34 or other user input devices may be used to cause the microcontroller 62 to activate one or more applications in response to operation of those user input devices. For example, each of the buttons 30, 32 and 34 may independently activate a different data capture method able to be operated by the intelligent case 10. In this way, different data capture methods, such as barcodes, scanning, signature capture and module data capture can be selected and caused to operate by a user without relying upon intelligence provided in the handheld computer 40. Moreover, these buttons or other user input devices may be used in combination. For example, when the first and second buttons 30 and 32 are pressed simultaneously for more than a predetermined time, the intelligent case 10 may trigger a GPS tracking function. It will also be appreciated that the microcontroller 62 may enable different applications or functions to be provided depending upon the length of the time that one or a series or combination of buttons or other user input devices are activated. For example, when the third button 34 is pressed for more than a predetermined time, a built-in torch light may be toggled on or off by the module manager 82.

Data captured by one or more intelligent cases 10 each housing a handheld computer 40, may be transmitted to a central data monitoring station. As shown in FIG. 7, the handheld computer 40 within the intelligent case 10 may be adapted to communicate with a mobile communications network 88.

Data from each intelligent case 10 is thus able to be transmitted via the mobile communications network 88 through a router and firewall 90 and switch 92 to servers 94 and 96. The data collected in this way is able to be received and analysed by back end applications 98 and administrator or like interfaces 100.

There will now be described a series of exemplary functions able to be performed by the intelligent case 10. As previously described, the various user applications causing the module manager 82 to implement desired functionality of the intelligent case 10 may be maintained in the non-volatile memory 78 or alternately may be maintained in the handheld computer 40. Accordingly, the microcontroller 62 may be placed in two modes. These modes may be activated by selection of an appropriate user input in communication with the microcontroller 62. In “dumb” mode, a user application found in the handheld computer 40 determines which modules and features are used. Once a data-capture module is activated, data is collected and passed to the handheld computer 40 via the module manager 82. In “smart” mode, user applications can be uploaded into the non-volatile memory 78, for example via the microcontroller 62. The functional series of steps shown in FIG. 8 operate whenever power is provided to the intelligent case 10. At step 100, the microcontroller 62 determines whether “smart” mode has been selected. If this is the case, then a command activate routine is initiated and active scanning routine 104 continually scans for activation of one of the user input buttons 30, 32 and/or 34. Selection of one or more of the buttons 30, 32 and 34 may cause various user applications maintained in the non-volatile memory 78 to enact different functionality in the intelligent case 10 via the module manager 82. In this case, activation of an appropriate sequence of buttons will cause a route track routine 106 to be activated.

However, if at step 100 smart mode was not initiated, then at step 102 is determined whether “dumb” mode has been activated. In this case, the user applications 84 stored in the handheld computer 40 determine which modules and features are used. Accordingly, at step 110, the module manager 82 waits for a command to be received from the handheld computer 40 to activate a desired module. At step 112 that module is activated and data from the relevant data-capture module is collected. If it is determined at step 114 that encryption is required, then the data is encrypted at step 116 and transmitted to a central data monitoring station by the handheld computer 40. If encryption is not required, then at step 118 the unencrypted data is similarly transmitted. If neither smart nor dumb modes are operated, then a system watchdog routine 120 places the module manager 82 in a waiting state.

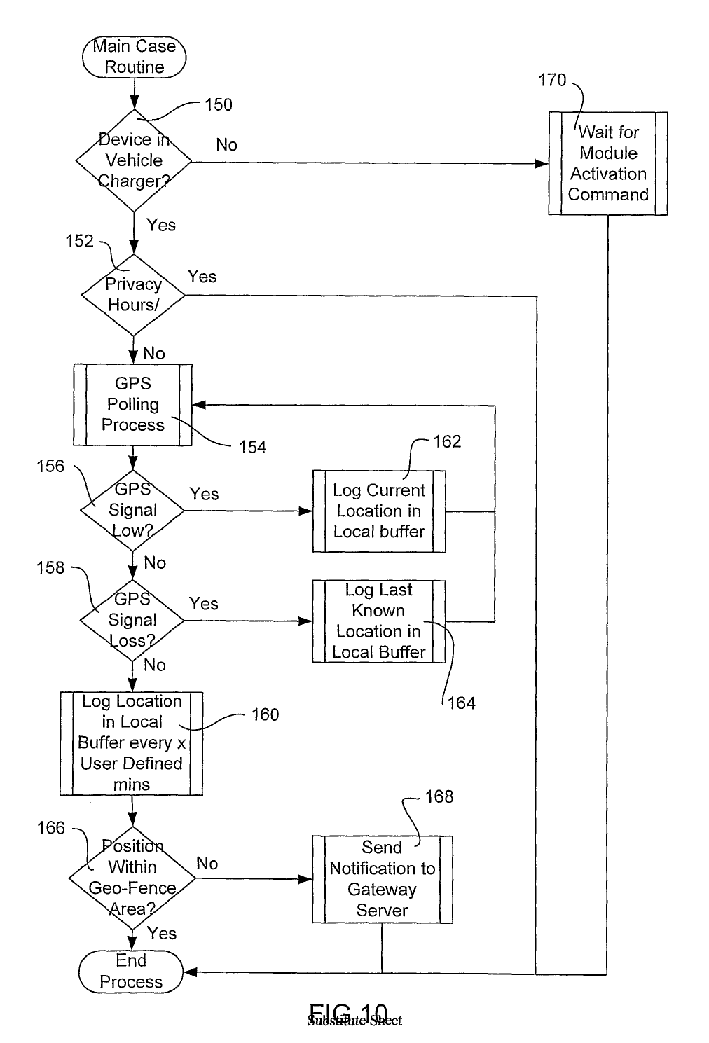

FIG. 9 describes in more detail the various steps carried out during the active scanning routine 104. If it is determined at step 122 by the microcontroller 62 that a predefined sequence of user buttons have been depressed, then various actions are undertaken depending upon the particular sequence. If an emergency sequence has been pressed, as determined by the microcontroller at step 124, then the current location or last known location is determined at step 126, for example, by capturing location information from a GPS data-capture module housed within the intelligent case 10. Once that information is obtained, then at step 128 a notification and the location data are sent to a central data monitoring station for further action. Such action may include, for example, providing either an automated or manual notification to a security service.

If a first of the buttons 30 to 34 has been depressed, as determined at step 130, then a first of the data-capture modules housed within the intelligent case 10 is activated at step 132 and data captured by that module. Similarly, if it is determined at step 134 that a second of the buttons has been depressed, then a second module is activated at step 136, and if it is determined at step 138 that a third button has been depressed, then a third data-capture module is activated at step 140. Exemplary data-capture modules may be a barcode scanning module, signature capture module and GPS module.

Although not shown in FIG. 9, when the first and second buttons are pressed simultaneously for more than a predetermined time, or other sequence of buttons are activated, other data-capture modules and functions associated with that data-capture module or modules, may be initiated.

FIG. 10 depicts one such example. In this figure, a “route tracker’ function is initiated which enables GPS tracking when the intelligent case 10 is attached to an in-vehicle cradle. If it is detected at step 150 that the smart case 10 is in such a cradle or charger, and if it is determined at step 152 that the current time is not during privacy hours of the user associated with the intelligent case 10, then a GPS poling process is initiated at step 154. If the GPS signal is not determined to be either low or a GPS signal loss has occurred, at steps 156 and 158, then the location of the intelligent case 10, as determined by the GPS module, is logged every X minutes for every user at step 160.

If the GPS signal is low or a signal loss is detected, then the current location of the intelligent case is logged, respectively at steps 162 and steps 162 and 164 prior to resuming the GPS poling process at step 154. If it is determined at step 156 that the location of the intelligent case 10 falls within a zone in which the user of the intelligent case 10 is permitted to travel, then no action is taken. However, if the intelligent case is found to be outside of that zone or “geo-fence”, then a notification is transmitted to a remote data monitoring station at step 168 and an appropriate action taken. Such a function may be particularly useful in the case of managing taxis fleets, sales personnel or the like. The location information is derived from the GPS data-capture module, and the time information may be captured either from the GPS data-capture module or from the internal system clock 80 within the intelligent case 10.

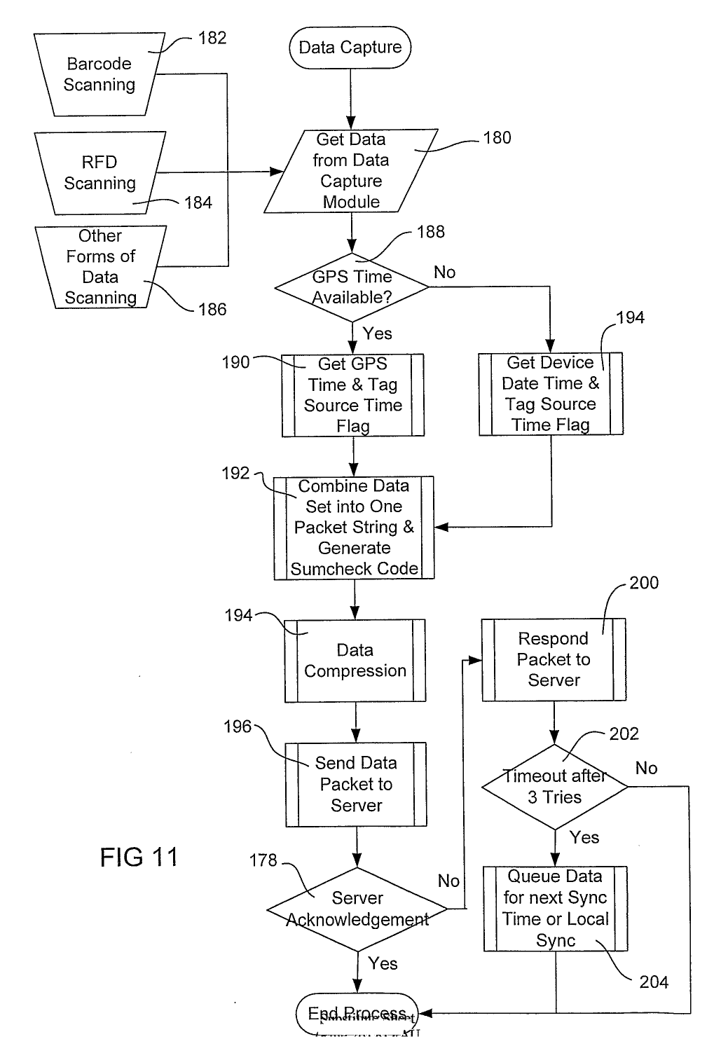

Other exemplary functionality implemented by the intelligent case 10 is depicted in FIG. 11. In this example, a “date and time stamping” function is carried out by which captured data is stamped with date and/or time information from a GPS data-capture module or a built-in clock for auditing purposes. Accordingly, at step 180, data from a relevant data-capture module is captured. In this figure, a barcode scanning module 182, RFID scanning module 184 and third data-capture module 186 are depicted. When that data is captured, if the date or time of the data capture is available from a GPS data-capture module, as determined at step 188, then a time and/or date stamp is derived at step 190, and then at step 192, combined into a data packet with the data captured at step 180. If a GPS data-capture module is not available, then at step 194 the time and/or date tag is generated from the internal system clock 80.

Subsequently, at step 194, the data and tag are compressed. At step 196 the data is sent to a remote data monitoring station. If server acknowledgement is not received at step 198, then the data packet is resent at step 200. If a time out occurs at step 202 after three attempts, then the data is queued at step 204 for the next synchronization time or local synchronization time.

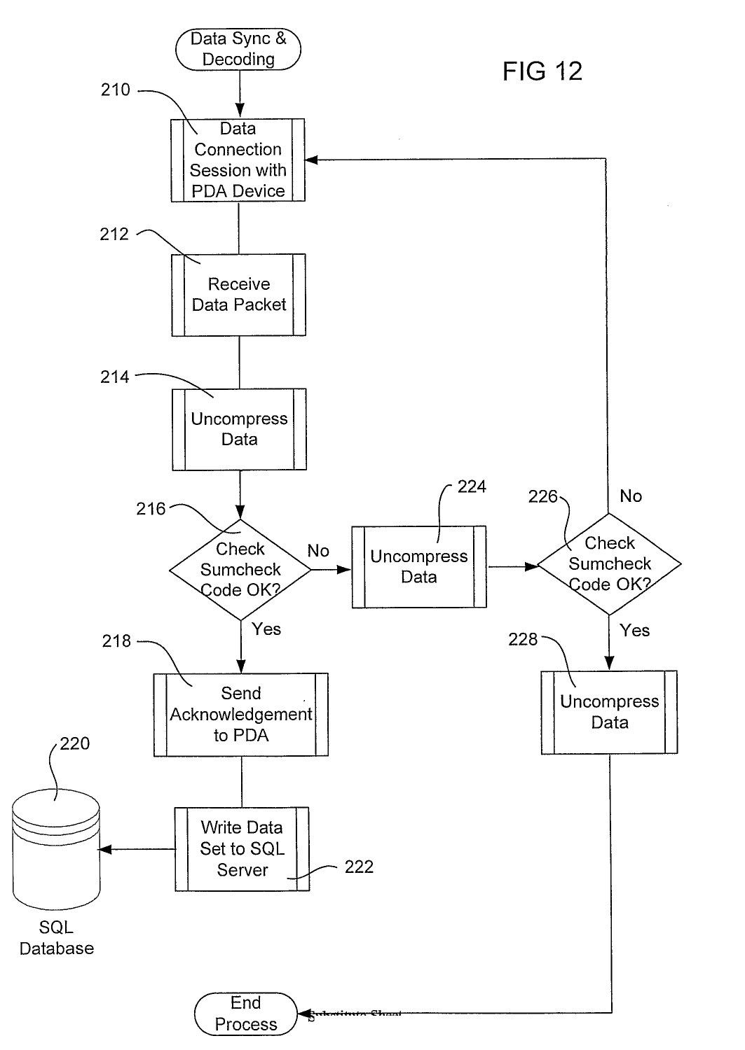

The steps implemented at the remote data monitoring station are shown in FIG. 12. Accordingly, at step 210, a data connection session is established with the handheld computer 40 at step 210. Upon receipt of the data packet at step 212, the data is compressed at step 214 and then the checksum derived from the data and/or time stamp is analysed. If the checksum is determined to be okay, then an acknowledgement is sent to the handheld computer 40 at step 218. The recovered data is then written to a database 220 at step 222. If the checksum is not validated at step 216, then at step 224, a request is transmitted to the handheld computer 40 for the retransmission of data. If a time add occurs after three attempts at step 226, then a reference is logged at step 228 for later synchronization.

Whilst the process depicted in FIGS. 11 and 12 relied upon date and time stamping with data collected from a GPS data-capture module or built-in clock for auditing purposes, a more complicated procedure can be developed using the user's GPS location, captured data and user identification to create a unique “proof of receive/proof of ID” stamping for auditing purposes.

Using GPS coordinates and date and time data from the GPS data-capture module, data captured using one of the modules, (for example, a barcode reader, magnetic card reader, smart card reader, etc) and user ID from a signature capture module, biometric scanning module or PIN entry module, are combined into a security encrypted packet with the sumcheck and stored into a local memory. This unique data collected can then be used for auditing purposes.

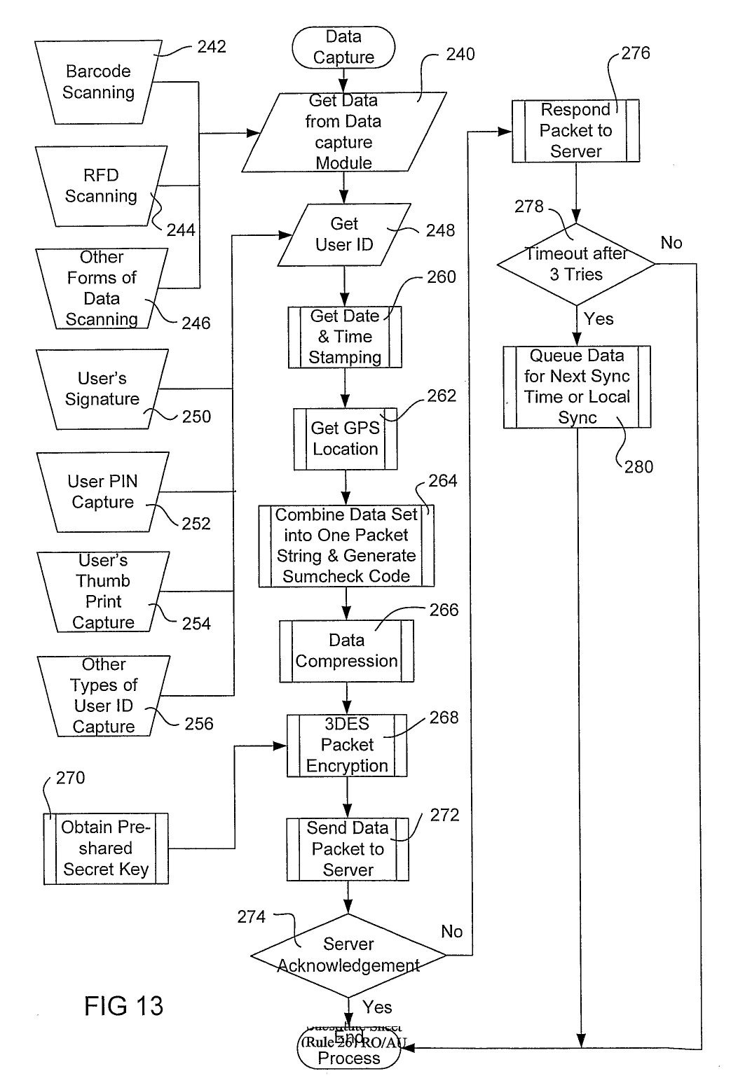

Accordingly, at step 240 in FIG. 13, data is captured from a particular data-capture module housed in the intelligent case 10. In FIG. 13, exemplary data-capture modules 242, 244 and 246 are depicted. At step 248, user identification information is captured from a suitable data-capture module. In this example, exemplary user identification data-capture modules 250 to 256 are depicted. It will be appreciated that in different embodiments of the invention only one of each category of data-capture modules may be included in any particular intelligent case 10 configuration.

At step 260, date and time stamping information is gathered from either a GPS time capture module or the internal system clock 80. At step 262, location information is gathered from a GPS data-capture module. At step 264, data captured at step 240, user identification information captured at step 248 and location information captured at step 262 is combined into a single packet string and a sumcheck code generated. At step 266 the data is compressed, and following encryption at step 268 (having firstly obtained a pre-shared secret key at step 270) the data packet is transmitted to a remote data monitoring station at step 272. If no server acknowledgement is received at step 274, then the data packet is resent at step 276.

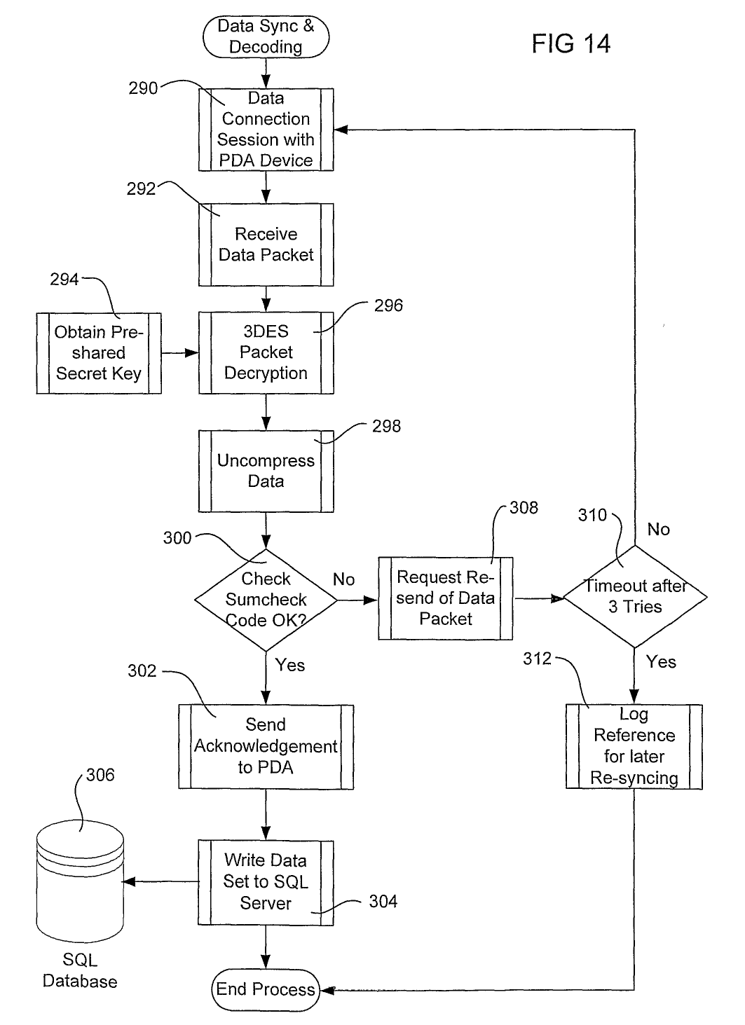

If a time add occurs after three attempts at step 278, then the data queued at step 280 for a next synchronization time or local synchronisation. At the remote data monitoring station, at step 290 in FIG. 14, a data connection session is established with the handheld computer 40. When a data packet is received at step 292, then the pre-shared secret key 294 is used to decrypt the received data packet at step 296. The decrypted data is then uncompressed at step 298 and the checksum verified at step 300. If the checksum is okay, then at step 302 an acknowledgement is sent to the handheld computer 40 and data written at step 304 to a database 306. If the checksum is not okay, then a request is generated at step 308 for the data to be resent. If a time add has occurred after three attempts at step 310, then a reference is logged for later re-synching at step 312.

It will be appreciated to those skilled in the art that many alternatives, modifications and variations are possible in light of the foregoing description. Accordingly, the present invention is intended to embrace all such alternatives, modifications and variations as may fall within the spirit and scope of the invention as disclosed.

1. An intelligent case for a handheld computer, the case including:
a compartment for removably housing the handheld computer;
a microcontroller;
a first communication device to enable communication between the handheld computer and the microcontroller;
one or more recesses for housing one or more data-capture modules; and
a second communication device to enable communication between the data-capture modules and the microcontroller;
wherein the microcontroller includes:
a module manager adapted to handle
activation of the data-capture modules,
collection of data from the data-capture modules, and
communication of the collected data to the hand-held computer; and
a first set of applications for controlling, in a first mode, at least some operations of the module manager independently of the handheld computer.

2. An intelligent case according to claim 1, and further including one or more user input devices, wherein the microcontroller is further adapted to activate one or more of the first set of applications in response to operation of the user input devices.

3. An intelligent case according to claim 2, wherein the one or more of the first set of applications activated in response to operation of the user input devices are programmable.

4. An intelligent case according to claim 1, wherein:
at least some operations of the module manager are controllable, in a second mode, by a second set of applications stored on the handheld computer.

5. An intelligent case according to claim 4, wherein the microcontroller is adapted to be placed in either the first or second mode.

6. An intelligent case according to claim 5, wherein the microcontroller is placed in either the first or second mode in response to operation of a user input device.

7. An intelligent case according to claim 1, wherein the module manager is further adapted to handle:
identification of available modules.

8. An intelligent case according to claim 1, wherein the module manager is further adapted to handle:
activation of features available within each module.

9. An intelligent case according to claim 1, wherein the module manager is further adapted to handle:
power management of the data-caputure modules.

10. An intelligent case according to claim 1, wherein the module manager acts to apply a date or time stamp to data captured from at least one of the data-capture modules.

11. An intelligent case according to claim 10, wherein including a local clock, wherein the module manager derives the date or time stamp from the local clock.

12. An intelligent case according to claim 10, wherein the module manager derives the date or time stamp from a local clock maintained by the handheld computer.

13. An intelligent case according to claim 10, and further including a GPS data-capture module, wherein the module manager derives the date or time stamp from the GPS data-capture module.

14. An intelligent case according to claim 1, wherein the module manager acts to apply location information to the data captured from at least one of the data-capture modules.

15. An intelligent case according to claim 14 when dependant upon claim 13, wherein the module manager derives the location information from the GPS data-capture module.

16. An intelligent case according to claim 1, wherein the module manager acts to apply user identification information to the data captured from at least one of the data-capture modules.

17. An intelligent case according to claim 16, and further including a user identification module, wherein the module manager derives the user identification information from the user identification module.

18. An intelligent case according to claim 17, wherein the user identification module captures user identification information from any one of a signature detection device, biometric scanning device or PIN entry device.

19. An intelligent case according to claim 1, wherein
at least one of the data-capture modules is built in to the case.

20. An intelligent case according to claim 1, wherein
at least one of the data-capture modules is removably affixed to or in the case.

21. An intelligent case according to claim 1, wherein the first communication device establishes a wireless communication link with the handheld computer.

22. An intelligent case according to claim 1, where at least one of the data-capture modules is a barcode scanner.

23. An intelligent case according to claim 1, and further including a touch screen, where at least one of the data-capture modules is a touch screen controller for transmitting user input signals from the touch screen to the microcontroller.

24. A data monitoring system including:
one or more intelligent cases according to claim 1, each case housing a handheld computer; and
a central data monitoring station,
wherein the handheld computers are adapted to transmit data captured from the data-capture modules to the central data monitoring station.

25. A data monitoring system according to claim 24, wherein the central data monitoring station includes one or more data monitoring applications for receiving and analysing data received from the handheld computers.
